(19) United States
(12) Patent Application Publication
(10) Pub. No.: US 2012/0043806 A1
(43) Pub. Date: Feb. 23, 2012

(54) Slip-Controlled Hydraulic Vehicle Brake System

(75) Inventors: Steffen Linkenbach, Eschborn (DE); Johann Jungbecker, Badenheim (DE); Lothar Schiel, Hofheim (DE); Stefan A. Drumm, Saulheim (DE)

(73) Assignee: Continental Teves AG & Co. OHG, Frankfurt (DE)

(21) Appl. No.: 13/266,587

(22) PCT Filed: Apr. 19, 2010
(86) PCT No.: PCT/EP10/55098

§ 371 Date: Oct. 27, 2011

(30) Foreign Application Priority Data
Apr. 28, 2009 (DE) 10 2009 002 695.9
Oct. 15, 2009 (DE) 10 2009 045 714.3

(51) Int. Cl. B60T 8/17; B60T 8/176; B60T 13/68; B60T 8/34

(52) U.S. Cl. 303/113.1

(57) ABSTRACT

A hydraulic vehicle brake system and method of operating same. The system includes an electrohydraulic wheel brake pressure modulation unit, a master brake cylinder (11) which has a pressure medium storage reservoir (12) for hydraulic brake fluid and which can be actuated by means of a brake pedal (9) and to which first and second brake circuits (I, II) are connected. Wheel brakes (3, 4, 5, 6) are connected to the first and second brake circuits (I, II). Each of the first and second brake circuits have a pair of inlets valves (14a-d, 114a-b) and a pair of outlet valves (15a-d, 115a-b) connected to the wheel brakes (3, 4, 5, 6). The outlets of the outlet valves (15a-d, 115a-b) of each of the first and second brake circuits (I, II) are connected to one another by means of jointly used hydraulic line sections (16a, 16b). A safety valve (17a, 117a; 17b, 117b) is provided by means of which an outflow of brake fluid medium out of the line section (16a, 16b) via an outlet port of the safety valves (17a, 117a; 17b, 117b) can be monitored as a means of checking the leak-tightness of the outlet valve and the safety valve.

### CROSS REFERENCE TO RELATED APPLICATIONS

This application claims priority to German Patent Application No. 10 2009 002 695.9, filed Apr. 28, 2009, German Patent Application No. 10 2009 045 714.3, filed Oct. 15, 2009, and PCT International Patent Application No. PCT/EP2010/055098, filed Apr. 19, 2010.

### FIELD OF THE INVENTION

The present invention relates to a hydraulic vehicle brake system with slip regulation, and to a method for operating a brake system.

### BACKGROUND OF THE INVENTION

A vehicle brake system of the above mentioned type is known for example from the international patent application WO 2008/017548. In the already known, preferably two-circuit brake system, a hydraulic line section which connects the outlet ports of outlet valves of a brake circuit is connected to a pressure medium storage reservoir and to the suction side of a hydraulic pump whose pressure side is connected via the inlet valves to vehicle wheel brakes.

It is considered to be a disadvantage of the known vehicle brake system that a leak of an outlet valve results in an elongation of the brake pedal actuating travel, wherein when the associated pressure chamber of the master brake cylinder is exhausted, the brake circuit connected thereto may fail.

It is therefore an object of the present invention, in a vehicle brake system of the generic type specified in the introduction, to propose measures which permit an increase in the operational reliability or a check of the leak-tightness of the outlet valves.

The above-mentioned object is achieved according to the invention, wherein features of a method for checking the leak-tightness of the outlet valves are also provided.

Advantageous further refinements of the vehicle brake system according to the invention are provided with further advantageous features of methods of operating a braking system.

Additional benefits and advantages of the present invention will become apparent to those skilled in the art to which the present invention relates from subsequent description of the preferred embodiment and the appended claims, taken in conjunction with the accompanying drawings.

### BRIEF DESCRIPTION OF THE DRAWINGS

FIG. 1 is a schematic view of a hydraulic braking system in accordance with a first embodiment of the invention; and

FIG. 2 is a schematic view of a hydraulic braking system in accordance with a second embodiment of the invention.

### DETAILED DESCRIPTION OF THE INVENTION

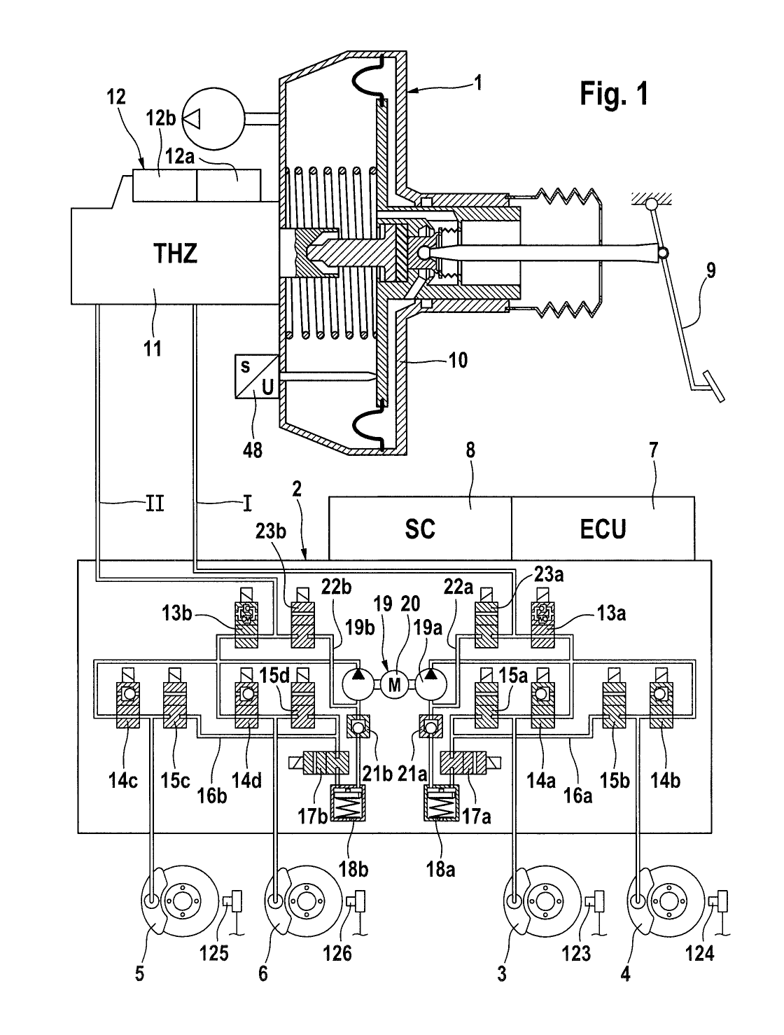

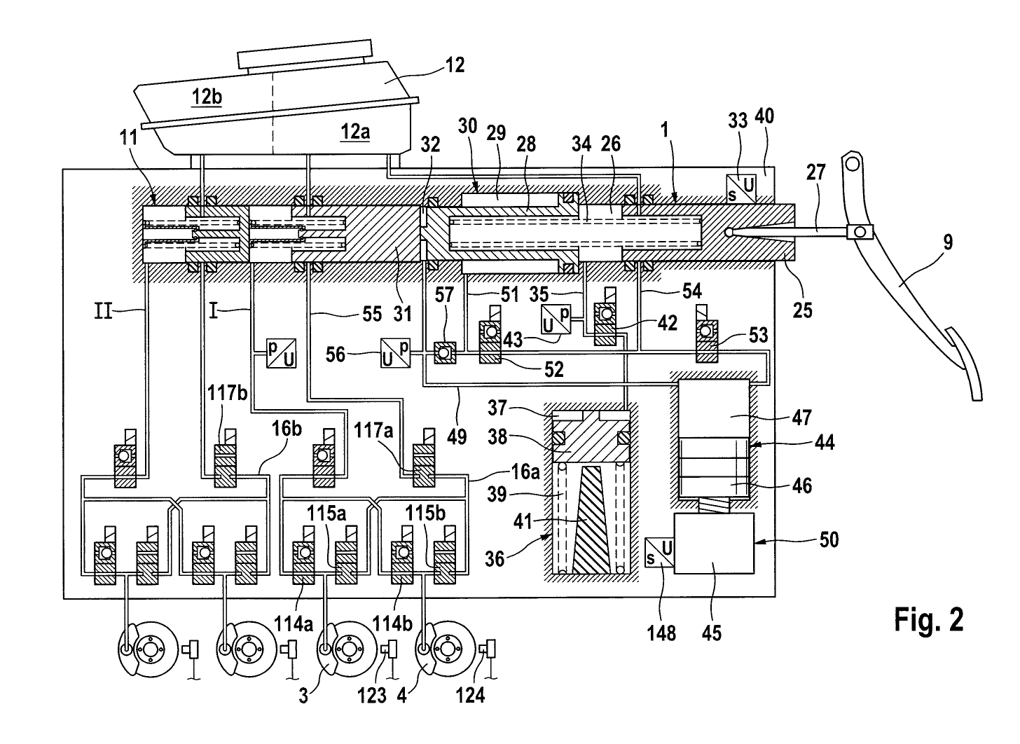

The invention will be explained in more detail below on the basis of two exemplary embodiments illustrated in the appended drawing. Here, FIGS. 1 and 2 each show a hydraulic circuit diagram of a first and a second embodiment of a vehicle brake system according to the invention.

The first embodiment of the vehicle brake system according to the invention, as shown in FIGS. 1, is provided for carrying out slip control processes, in particular anti-lock brake system (ABS), traction control (or anti-spin regulation (ASR)) and driving dynamics control (electronic stability program (ESP)). The brake system, which preferably has two brake circuits I and II consists substantially of an actuation unit 1, a wheel brake pressure modulation device 2 which is connected to the actuation unit 1, wheel brakes 3, 4, 5, 6 which are connected to the wheel brake pressure modulation device 2, and an electronic control and regulating unit (ECU) 7 assigned to the brake pressure modulation device 2. The reference numeral 8 denotes a sensor cluster (SC) which comprises the sensors required for carrying out the abovementioned regulating processes, the output signals of which sensors are supplied to the electronic control and regulating unit 7. Here, the assignment of the wheel brakes 3-6 to the brake circuits I and II is such that the wheel brakes 3 and 4 connected to the first brake circuit I are assigned to the vehicle rear axle, while the wheel brakes 5 and 6 connected to the second brake circuit II serve for braking the vehicle front axle. Wheel rotational speed sensors 123, 124, 125, and 126 serve for the direct measurement of the wheel rotational speeds and the indirect measurement of the pressure set in the wheel brakes 3-6 during a braking process.

As can also be seen from FIG. 1, the actuation unit 1 consists of a preferably pneumatic brake force booster 10 and of a two-circuit master brake cylinder 11 which in operational terms is connected downstream of the brake force booster 10, to the pressure chambers (not illustrated) of which master brake cylinder the abovementioned brake circuits I and II are connected. A brake pedal denoted by the reference numeral 9 serves for the actuation of the described assembly. Furthermore, the master brake cylinder 11 is connected to a pressure medium (brake fluid) storage reservoir 12 whose chambers 12a and 12b are assigned to the master brake cylinder pressure chambers of the brake circuits I and II. The actuating travel of the brake pedal 9 is detected by means of a travel sensor 48 which senses the travel of the movable wall of the brake force booster 10 during an actuation.

The wheel brake pressure modulation device 2 comprises block valves 13a and 13b which are connected to the brake circuits I and II, which are designed as 2/2 directional valves which are open in the deenergized state, and to the outlets of which are connected inlet valves 14a-d assigned to the wheel brakes 3-6, which inlet valves, in the open basic position in the deenergized state, permit a joint pressure build-up and dissipation and, upon electronic actuation, permit a different build-up of a hydraulic pressure in the wheel brakes 3-6 in a wheel-specific manner. A different dissipation of the pressure set in the wheel brakes 3-6 in a wheel-specific manner is realized by means of outlet valves 15a-d, wherein the outlets of the outlet valves 15a and 15b, and 15c and 15d assigned to the brake circuits I and II are connected to in each case one jointly used line sections 16a and 16b. The line sections 16a and 16b lead to in each case one of safety outlet valves 17a and 17b, the outlet of which is connected to in each case one of hydraulic low-pressure accumulators 18a and 18b. Furthermore, each brake circuit I and II is assigned a circuit 19a and 19b of a two-circuit hydraulic pump 19 which is driven by means of an electric motor 20 and the suction side of which is connected to the low-pressure accumulators 18a and 18b via check valves 21a and 21b which close in the direction of the low-pressure accumulators 18a and 18b. Further line sections 22a and 22b branch off from the section between the check valves 21a and 21b and the pumps 19a and 19b, which further line sections 22a and 22b is connected, with the interposition of in each case one 2/2 directional valve 23a and 23b which is closed in the deenergized state, to the inlet port of the abovementioned block valves 13a and 13b or the brake circuits I and II. All of the valves described in this context are designed as electromagnetically actuable 2/2 directional valves, wherein in particular the individual pairs of inlet 14a-d and outlet valves 15a-d assigned to the individual wheel brakes 3-6 can be combined to form a 3/2 directional valve. Here, the inlet valves 14a-d are designed as 2/2 directional valves which are open in the deenergized state and which, in the energized state, perform the function of check valves which close in the direction of the wheel brake 3-6, while the outlet valves 15a-d and the safety outlet valves 17a and 17b are designed as 2/2 directional valves which are closed in the deenergized state.

During a check for leak-tightness, which is carried out during a pressure holding phase for example at one of the outlet valves 15a or 15b assigned to the vehicle front axle, both the inlet valves 14a and 14b and also the outlet valves 15a and 15b are closed. For the purpose of the leak-tightness check, the corresponding safety outlet valve 17a is now opened. If one of the two outlet valves 15a or 15b has a leak, pressure medium flows out of the associated wheel brake 3 or 4 into the low-pressure accumulator 18a via the outlet valve 15a or 15b which has a leak. The resulting diminishing braking action is detected from the corresponding output signal of one of the abovementioned rotational speed sensors 123 or 124.

During a check of the leak-tightness of the safety outlet valve 17a, the inlet valve 14b is for example closed while the corresponding outlet valve 15b is opened. If the safety outlet valve 17a has a leak, pressure medium flows out into the low-pressure accumulator 18a, which results in a loss of pressure medium and therefore a diminishing braking action of the wheel brake 4. The diminishing braking action is detected again from the corresponding output signal of the rotational speed sensor 124. The same approach self-evidently also applies to the other inlet and outlet valve pair 14a and 15a.

FIG. 2 of the appended drawing shows an electrohydraulic brake system which can be operated in particular in a so-called “brake-by-wire” operating mode. Here, those parts of the brake system illustrated in FIG. 2 which correspond to the components shown in FIG. 1 are denoted by the same reference numerals. The actuation unit 1 has a first piston 25 which delimits a hydraulic pressure chamber 26 and which is coupled via a thrust rod 27, which transmits actuating forces, to the brake pedal 9. The actuation travel of the brake pedal 9 is detected by means of a travel sensor 33 which is preferably of redundant configuration and which senses the travel of the first piston 25. The pressure chamber 26 can be connected to the pressure medium storage reservoir 12, wherein said connection can be shut off by means of a relative movement of the first piston 25 with respect to a merely schematically indicated housing 40 in which the first piston 25 is guided. The actuation unit 1 is in operational terms connected downstream of a pedal decoupling unit 30 which is formed by a second piston 28, which is likewise guided in the housing 40, and by a hydraulic chamber 29 which is delimited by the second piston 28 in the housing 40, the pressurization of which hydraulic chamber prevents a movement of the second piston 28 in the actuation direction. The second piston 28 constitutes a second delimitation of the above mentioned hydraulic chamber 26, wherein a restoring spring is 34 arranged between the two pistons 25 and 28. Furthermore, the second piston 28 can be connected in a force-transmitting manner to a first or primary piston 31 of the master brake cylinder 11, wherein an intermediate chamber 32 which can be charged with hydraulic pressure is provided between the second piston 28 and the primary piston 31, the pressurization of which intermediate chamber loads the second piston 28 and the primary piston 31 in opposite directions.

It can also be seen from FIG. 2 that the abovementioned pressure chamber 26 is connected via a connecting line 35, which can be shut off, to a hydraulically actuable travel simulation device 36. The travel simulation device 36 has a simulator chamber 37 which is delimited by a simulator piston 38. Here, the simulator piston 38 interacts with a simulator spring 39 and with an elastomer spring 41 which is connected in parallel with the simulator spring 39. The shutting-off of the connecting line 35 takes place by means of a simulator shut-off valve 42 which is designed as an electromagnetically actuable 2/2 directional valve which is open in the deenergized state and which, in the energized state, performs the function of a check valve which closes in the direction of the simulator chamber 37. A pressure sensor 43 serves for detecting the pressure prevailing in the pressure chamber 26.

To realize the abovementioned “brake-by-wire” operating mode, an electrohydraulic pressure provision device 50 is provided which is formed from a hydraulic cylinder-piston arrangement 44 and from an electromechanical actuator 45. Here, the electromechanical actuator 45 is designed as an electric motor with a step-down gearing, which ensures a translatory movement of a piston 46, such that a hydraulic pressure is built up in a pressure chamber 47 of the hydraulic cylinder-piston arrangement 44. The movement of the piston 46 is detected indirectly by a travel sensor 148 assigned to the actuator 45. To charge the abovementioned intermediate chamber 32 with hydraulic pressure during a “brake-by-wire” braking operation, a first connecting line 49 is provided between the pressure chamber 47 of the hydraulic cylinder-piston arrangement 44 and the intermediate chamber 32, to which first connecting line is connected a first pressure sensor 56. A second connecting line 51, in which is situated a second electromagnetically actuable 2/2 directional control valve 52 which is open in the deenergized state, forms a hydraulic connection, which can be shut off, between the hydraulic chamber 29 and the pressure chamber 47 of the hydraulic cylinder-piston arrangement 44. Here, a check valve 57 which closes in the direction of the intermediate chamber 32 is connected between the first connecting line 49 and the second connecting line 51. In the second connecting line 51, there is connected upstream of the 2/2 directional valve 52 a third electromagnetically actuable 2/2 directional valve 53 which is open in the deenergized state and to the outlet port of which is connected a third connecting line 54 which is connected to the pressure medium storage reservoir 12.

The assignment of the wheel brake pressure modulation valves or of the inlet and outlet valves and of the safety outlet valves to the individual brake circuits I and II corresponds to FIG. 1 as explained above, with the exception of the fact that the reference numerals allocated to the said valves have been increased by 100 in FIG. 2. Here, the outlet ports of the safety outlet valves 117a and 117b are permanently connected via pressure dissipation lines 55 to the chambers 12a and 12b which are assigned to the individual brake circuits I and II of the pressure medium storage reservoir 12.

During a check for leak-tightness carried out during a braking operation for example at one of the outlet valves 115a or 115b assigned to the vehicle front axle, the inlet valves 114a and 114b are opened while the outlet valves 115a and 115b are closed. For the purpose of the leak-tightness check, the corresponding safety outlet valve 117a is now opened. If one of the two outlet valves 115a or 115b has a leak, pressure medium flows out of the associated wheel brake 3 or 4 via the leaking outlet valve 115a or 115b into that chamber 12a of the pressure medium storage reservoir 12 which is assigned to the brake circuit I. By monitoring the volume consumption by means of the travel sensor 148, if an outlet valve or safety outlet valve has a leak, an excessive volume consumption in relation to the master brake cylinder pressure is detected. Here, on the basis of the assignment of the occurrence of an additional volume consumption to the individual valve opening actions, it is detected whether one of the outlet valves or the safety outlet valve has the leak. After the discovery of a leak in one of the outlet valves, it is subsequently detected which of the two outlet valves of the brake circuit in question has the leak. For this purpose, the corresponding inlet valves 114a and 114b are closed, such that no pressure medium volume can be supplied to the wheel brakes 3 and 4 by the electrohydraulic pressure provision device 50. As a result of a leak of one of the two outlet valves 115a or 115b, the braking action at the associated wheel brake 3 or 4 diminishes, and this is detected from the corresponding output signal of one of the abovementioned rotational speed sensors 123 or 124.

During a check of the leak-tightness of the safety outlet valve 117a, the outlet valve 115b is for example opened while the corresponding inlet valve 114b remains open. If the safety outlet valve 117a has a leak, the pressure medium flows out into the associated chamber 12a of the pressure medium storage reservoir 12, such that the loss of pressure medium caused in this way must be replenished by the electrohydraulic pressure provision device 50. The replenishment of the pressure medium volume is determined indirectly at the hydraulic actuator 50 from the travel of the piston 46 detected by the travel sensor 148.

The same approach is self-evidently also used for the other inlet and outlet valve pair 114a and 115a.

While the above description constitutes the preferred embodiment of the present invention, it will be appreciated that the invention is susceptible to modification, variation, and change without departing from the proper scope and fair meaning of the accompanying claims.

1. A hydraulic vehicle brake system with slip regulation, of the type having an electrohydraulic wheel brake pressure modulation unit, a master brake cylinder (11) which has a pressure medium storage reservoir (12) for a hydraulic fluid, and which can be actuated by means of a brake pedal (9) and to which first and second brake circuits (I, II) are connected, wheel brakes (3, 4, 5, 6) which are connected to the first and second brake circuits (I, II), a pair of inlet valves (14a-d, 114a-b) and a pair of outlet valves (15a-d, 115a-b) being connected to the respective wheel brakes (3, 4, 5, 6), comprising the outlets of the outlet valves (15a-d, 115a-b) are connected to one another by a jointly used hydraulic line section (16a, 16b), a safety valve (17a, 117a; 17b, 117b) connected to the line section (16a, 16b) via an outlet port of the safety valve (17a, 117a; 17b, 117b) wherein, when the outlet valves (15a-d, 115a-b) are closed and the safety valve (17a, 17b, 117a and 117b) is opened, flow of the hydraulic fluid will occur upon leakage of the one or more of the outlet valves, and when one or more of the outlet valves is opened and the safety valve is closed, flow of the hydraulic fluid will occur upon leakage of the safety valve, and wherein the leakage is an indicator that one or both of the outlet valves or the safety valve is not leak-tight.

2. The vehicle brake system as claimed in claim 1, characterized further comprising in that the outlet port of the safety valve (17a, 17b) is connected to a low-pressure accumulator (18a, 18b).

3. The vehicle brake system as claimed in claim 1, further comprising in that the outlet port of the safety valve (117a, 117b) is connected to a chamber (12a, 12b), which is assigned to one of the brake circuits (I, II), of the pressure medium storage reservoir (12).

4. The vehicle brake system as claimed in claim 1, further comprising the vehicle brake system is designed as a “brake-by-wire”-type brake system.

5. The vehicle brake system as claimed in claim 4, further comprising in that a hydraulic pedal decoupling unit (30) is arranged between the brake pedal (9) and the master brake cylinder (11).

6. The vehicle brake system as claimed in claim 5, further comprising in that the pedal decoupling unit (30) interacts with an electrically controllable pressure provision device (50).

7. The vehicle brake system as claimed in claim 5, further comprising the pedal decoupling unit (30) acts as a hydraulically actuable travel simulation device (36).

8. A method for operating a hydraulic vehicle brake system with slip regulation, of the type having an electrohydraulic wheel brake pressure modulation unit having both inlet and outlet valves (14a-d, 114a-b, 15a-d, 115a-b), a master brake cylinder (11) which has a pressure medium storage reservoir (12) for a hydraulic fluid and which can be actuated by means of a brake pedal (9) and to which first and second brake circuits (I, II) are connected, wheel brakes (3, 4, 5, 6) which are connected to the brake circuits (I, II) via the inlet valves (14a-d, 114a-b) and the outlet valves (15a-d, 115a-b) being connected to the wheel brakes (3, 4, 5, 6), comprising the steps of providing the outlets of the outlet valves (15a-d, 115a-b) of one or both the brake circuits (I, II) connected to one another by means of a jointly used hydraulic line section (16a, 16b), providing a safety valve (17a, 17b; 117a, 117b), connected with the jointly used hydraulic line section, checking the leak-tightness of the outlet valves (15a-d; 115a-b) and of the safety valve (17a, 17b; 117a, 117b), which is connected to the line section (16a, 16b), during a braking process, the outlet valves (15a-d; 115a-b) and the safety valve (17a, 17b; 117a, 117b) opening individually and in a time-offset manner, and the associated reactions of the brake system or of the vehicle are monitored, wherein, when the outlet valves (15a-d, 115a-b) are closed and the safety valve (17a, 17b, 117a, 117b) is opened, flow of the hydraulic fluid will occur upon leakage of one or both of the outlet valves, and when one or both the outlet valves is opened and the safety valve is closed, flow of the hydraulic fluid will occur upon leakage of the safety valve, and wherein the leakage is an indicator that one or both the outlet valves or the safety valve is not leak-tight.

9. The method as claimed in claim 8, further comprising in that, in the absence of a reaction to the individual and time-offset opening of one or both the outlet valves (15a-d; 115a-b) and of the safety valve (17a, 17b; 117a, 117b) of a brake circuit (I, II), it is inferred that the valves are leak-tight.

10. The method as claimed in claim 8, further comprising in that, by means of a travel sensor (48, 148), an excessive volume consumption of the pressure medium in relation to the master brake cylinder pressure is detected and, if present, it is inferred that the outlet valve or the safety valve is not leak-tight.

11. The method as claimed in claim 8 for operating a vehicle brake system further comprising in that the individual and time-offset opening of the outlet valves (15a-d) and of the safety valve (17a, 17b) is carried out during a pressure-holding phase, and at the same time at least one of the inlet valves (14a-d) is closed, wherein if a wheel brake pressure or a wheel brake action decreases, it is inferred that a closed outlet valve (15a-d) or the safety valve (17a, 17b) is not leak-tight.

12. The method as claimed in claim 8 for operating a vehicle brake system wherein the brake system is a brake-by-wire type further comprising in that the individual and time-offset opening of the outlet valves (115a, 115b) and of the safety valve (117a, 117b) is carried out with the inlet valves (114a, 114b) open, and the hydraulic fluid volume consumption of the brake system in order to maintain the braking action is monitored by means of an actuation travel sensor (148), and in the event of a loss of the hydraulic fluid, it is inferred that the closed outlet valve (115a, 115b) or the safety valve (117a) is not leak-tight.

13. The method as claimed in claim 11, further comprising in that, to check the leak-tightness of the outlet valves (115a, 115b), the safety valve (117a) is opened.

14. The method as claimed in claim 13, further comprising in that, if a leak of one of the outlet valves (115a, 115b) is detected, the outlet valve (115a, 115b) with a leak is determined by means of a time-offset closure of the inlet valves (114a, 114b).

15. The method as claimed in claim 11, further comprising in that, to check the leak-tightness of the safety valve (117a), one of the outlet valves (115a, 115b) is opened.
